(19) United States
(12) Patent Application Publication
(10) Pub. No.: US 2017/0237304 A1
(43) Pub. Date: Aug. 17, 2017

(54) STATOR FOR ROTARY ELECTRIC MACHINE

(71) Applicant: TOYOTA JIDOSHA KABUSHIKI KAISHA, Toyota-shi, Aichi-ken (JP)

(72) Inventors: Toshinori OKOCHI, Toyota-shi, Aichi-ken (JP); Hiroyuki HATTORI, Okazaki-shi, Aichi-ken (JP)

(73) Assignee: TOYOTA JIDOSHA KABUSHIKI KAISHA, Toyota-shi, Aichi-ken (JP)

(21) Appl. No.: 15/519,379

(22) PCT Filed: Oct. 13, 2015
(86) PCT No.: PCT/IB2015/001863

§ 371 Date: Apr. 14, 2017

(30) Foreign Application Priority Data
Oct. 15, 2014 (JP) 2014-210917

(51) Int. Cl. H02K 1/14; H02K 3/34; H02K 3/32

(52) U.S. Cl. CPC H02K 1/146; H02K 3/325; H02K 3/345

(57) ABSTRACT

A stator for a rotary electric machine includes an annular yoke, and teeth projecting from the yoke in a stator radial direction. Both ends of each of the teeth in a stator axial direction include reduced-width parts. The width of each of the reduced-width parts is smaller than the width of the remaining part of each of the teeth. Stator coils each is wound around each of the teeth in concentrated winding, and includes at least one curved portion in a coil end portion. The curved portion corresponds in position to at least part of the reduced-width parts.

### BACKGROUND OF THE INVENTION

1. Field of the Invention

The present invention relates to a stator for a rotary electric machine.

2. Description of Related Art

Conventionally, there has been known a rotary electric machine including a tubular stator provided with coils wound therearound, and a rotor rotatably provided inside the stator via a gap. The stator of the rotary electric machine may be configured such that a plurality of magnetic plates such as electromagnetic steel sheets, for example, is punched and laminated so as to be integrated with each other. Further, the stator generally includes a toric back yoke, and teeth projecting from the back yoke in a radial direction of the back yoke and formed at regular pitches in a circumferential direction of the back yoke.

A stator coil may be wound around each tooth of a stator core in concentrated winding. For example, Japanese. Patent Application Publication No. 2013-153615 (JP 2013-153615 A) describes a concentrated winding motor in which a tubular coil bobbin provided with a coil wound therearound is inserted from a tip end of each stator tooth, so as to be attached to a stator core.

### SUMMARY OF THE INVENTION

A coiled portion wound around the tooth as described above is formed in a coil shape by bending and winding a coil lead wire, which is a copper wire or the like covered with an enamel coating, for example. At this time, the coil lead wire is bent between a lead wire portion placed in a slot between teeth and a lead wire portion placed along an axial end surface of the tooth. If a curvature radius here is too small, an inner peripheral side of the coil lead wire becomes thick and a gap is formed between coil lead wires adjacent to each other, which leads to a decrease in a space factor. Further, an insulating coating is stretched to be thin on an outer side of a bending portion, which may decrease insulating properties. On that account, it is necessary to form the bending portion of the coil lead wire in a shape curved with a certain curvature radius. This is required particularly when a flat lead wire having a high rigidity is used as a coil lead wire.

In such a case, when the coil lead wire is formed so as to be curved from a position at which the coil lead wire comes out from the slot and to enter its adjacent slot in a curved manner across an axial end surface side of the tooth, a gap generally corresponding to the curvature radius is formed between the coil lead wire and the axial end surface of the tooth in a coil end portion, which is a part of the coiled portion which is placed outside the slot. As a result, a coil length increases by just that much, which leads to a decrease in loss such as copper loss.

The present invention provides a stator for a rotary electric machine, which stator can shorten a coil length while forming a bent portion in a coil lead wire of a concentrated winding coil so as to have a large curvature radius to some extent.

A stator for a rotary electric machine includes a stator core and stator coils. The stator core includes an annular yoke and teeth. The annular yoke extends in a stator circumferential direction. The teeth projects from the yoke in a stator radial direction, and are located at predetermined pitches in the stator circumferential direction. The stator core is a plurality of magnetic plates laminated in a stator axial direction. Each of the magnetic plates is in an annular shape. Both ends of each of the teeth in the stator axial direction includes reduced-width parts. The width of each of the reduced-width parts is smaller than the width of a remaining part of each of the teeth. Each of the stator coils includes at least one curved portion at which each of the stator coils is curved. The curved portion continues from one of slots of the stator core to one of coil end portions that are end portions of the stator coils in the stator axial direction. The curved portion corresponds in position to at least part of each of the reduced-width parts.

In the stator described above, the magnetic plates laminated in the reduced-width parts have a V-shape projecting outwardly in the stator axial direction.

In the stator described above, each of the teeth has a trapezoidal shape when viewed in the stator axial direction.

A stator for a rotary electric machine includes a stator core and a stator coil. The stator core includes an annular yoke and teeth. The teeth projects from the yoke toward a radially inner side of the stator, and are provided in the yoke at predetermined pitches in a stator circumferential direction. The yoke and the teeth are a plurality of magnetic plates laminated in a stator axial direction. The teeth each includes a first portion, a second portion, and a third portion. The first portion, the second portion, and the third portion are placed in the stator axial direction in order of the second portion, the first portion, and the third portion. The width of the first portion in the stator circumferential direction is larger than the width of the second portion in the stator circumferential direction. The width of the first portion in the stator circumferential direction is larger than the width of the third portion in the stator circumferential direction. Stepped portions are defined respectively by the first portion and the second portion and by the first portion and the third portion. The stepped portions each includes a first corner portion and a second corner portion. The stator coil is as a concentrated winding coil. The stator coil is wound around corresponding one of the teeth. The stator coil includes a plurality of curved portions. A straight line connecting the first corner portion to the second corner portion is placed between a center of the stator coil and a vertex of an arc of each of the curved portions on a cross-section of each of the teeth.

In the stator described above, the second portion and the third portion each have a V-shape projecting outwardly in the stator axial direction on a cross-section of each of the teeth.

In the stator described above, each of the teeth has a trapezoidal shape when viewed in the stator axial direction.

According to the stator for the rotary electric machine of the present embodiment, since the stator coil wound in a concentrated manner is configured such that the curved portion continuing from the slot of the stator core to the coil end portion, which is an end of the stator coil in a stator axial direction, corresponds to at least part of the reduced-width part, a coil lead wire constituting the stator coil can be curved from a position opposed to the reduced-width part in the stator circumferential direction, so as to be wound through a position close to an axial end surface of the tooth. On that account, a length of the coil lead wire constituting the stator coil can be shortened as compared with a case where a teeth width is uniform over the stator axial direction. Accordingly, it is possible to restrain loss such as copper loss by just that much, and to achieve cost reduction of the stator coil.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a rotary electric machine including a stator according to one embodiment of the present invention along a direction perpendicular to a stator axial direction;

FIG. 2 is a perspective view of an insulator;

FIG. 3A is a plan view of one tooth when viewed in the stator axial direction, and FIG. 3B is a sectional view taken along a line A-A in FIG. 1;

FIG. 4 is an enlarged view of a part C in FIG. 3B;

FIG. 5 illustrates a comparative example in which a width of a tooth in the section along the line A-A in FIG. 1 is uniform along the stator axial direction: FIG. 5A is a plan view of one tooth when viewed in the stator axial direction; and FIG. 5B is a sectional view of the tooth of the comparative example in a direction perpendicular to a stator radial direction;

FIG. 6A is a plan view of one tooth of a stator according to another embodiment, when viewed in a stator axial direction, and FIG. 6B is a sectional view corresponding to the section taken along the line A-A in FIG. 1;

FIG. 7 is a view corresponding to FIG. 3A and illustrates a modification in which a tooth width is uniform over the stator radial direction; and

FIG. 8 is a view corresponding to FIG. 3A and illustrates a modification in which a width of a toric yoke in the stator radial direction is uniform.

### DETAILED DESCRIPTION OF EMBODIMENTS

The following describes an embodiment of the present invention (herein referred to as the embodiment) in detail with reference to the attached drawings. In this description, specific shapes, materials, values, directions, and the like are examples to facilitate understanding of the present invention, and can be modified appropriately in conformity to a purpose, an object, a specification, and the like. Further, in a case where the following description includes a plurality of embodiments or modifications, it is assumed from the first that features of them are used in combination appropriately.

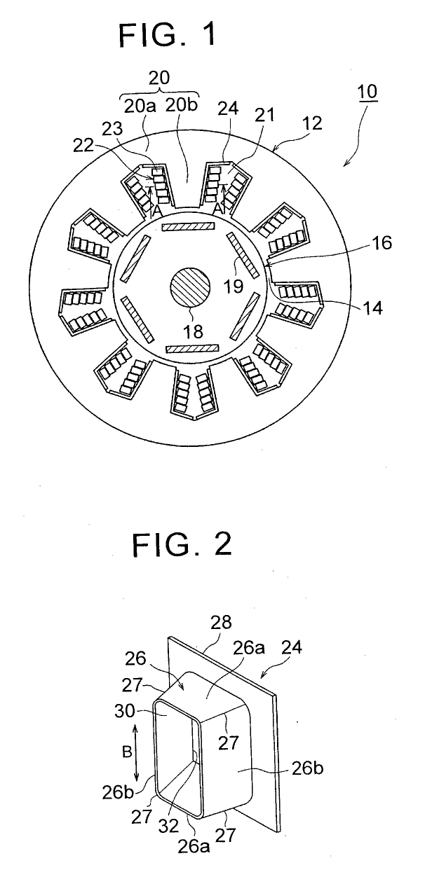

FIG. 1 is a sectional view of a rotary electric machine 10 including a stator 12 according to the present embodiment along a direction perpendicular to a stator axial direction. Further, in the following description of the present embodiment, a radial direction of the stator 12 is expressed as a stator radial direction, a direction along an outer periphery of the stator 12 is expressed as a stator circumferential direction, and an axial direction of the stator 12 is expressed as a stator axial direction, unless otherwise specified.

The rotary electric machine 10 has a generally cylindrical shape, and includes the stator 12, and a rotor 16 provided radially inside the stator 12 via the gap 14. The rotor 16 is rotatably supported by a case (not shown) in which to accommodate the rotary electric machine 10, via a shaft 18 fixed to a center of the rotor 16. FIG. 1 illustrates the rotor 16 including permanent magnets 19 therein, but the rotor 16 is not limited to this, and may be a rotor that does not includes permanent magnets.

The stator 12 includes a stator core 20, a stator coil 22 wound around the stator core 20, and an insulator 24 that insulates the stator core 20 from the stator coil 22.

The stator core 20 is constituted by a laminated body configured such that a plurality of magnetic plates such as electromagnetic steel sheets, for example, is punched in a generally toric shape and laminated in the stator axial direction so as to be integrally connected to each other by caulking, welding, or the like, for example. The stator core 20 includes a yoke 20a having a generally toric shape, and a plurality of teeth 20b projected radially inwardly from the yoke 20a and formed at predetermined pitches in the stator circumferential direction. The present embodiment exemplifies the stator core 20 having nine teeth 20b.

In the present embodiment, the teeth 20b are each formed in a trapezoidal shape when viewed in the stator axial direction. That is, the teeth 20b each have, on either circumferential side, a side face forming a tapered shape toward a tooth tip on a radially inner side. Further, an inner tip of each of the teeth 20b is not provided with a rib portion. Since the teeth 20b are each formed in a trapezoidal shape when viewed in the axial direction as such, there is such an advantage that an attachment operation of fitting the stator coil 22 (described later) and the insulator 24 from the radially inner side can be performed easily.

Further, a groove-shaped slot 21 is formed between the teeth 20b adjacent to each other in the stator circumferential direction. The groove-shaped slot 21 is formed so as to be opened on both axial sides and on the radially inner side. The present embodiment exemplifies the stator core 20 having nine slots 21, which is the same number as the teeth 20b. Further, the yoke 20a of the stator core 20 of the present embodiment is formed so as to have a shape that is wide in radial width at respective root portions of the teeth 20b, but is narrowest in radial width at respective central positions of the slots 21 in the stator circumferential direction.

The stator coil 22 is formed such that a coil lead wire 23 such as a copper wire having an insulating coating such as enamel, for example, is wound around the insulator 24. In the present embodiment, the stator coil 22 is wound around each tooth of the teeth 20b in concentrated winding. Further, as the coil lead wire 23 constituting the stator coil 22 of the present embodiment, a flat lead wire having a rectangular section is used, for example. However, the coil lead wire 23 is not limited to this, and a square-shaped lead wire having a square section may be used or a round-shaped lead wire having a round section may be used.

In a case where the rotary electric machine 10 is a three-phase alternating current motor, every third stator coil 22, i.e., three stator coils 22 among the nine stator coils 22 are electrically connected to each other by a bus bar (not shown), so as to constitute a U-phase coil. Further, every third stator coil 22, i.e., three stator coils 22 adjacent to one circumferential side of the U-phase coil are electrically connected to each other by a bus bar (not shown), so as to constitute a V-phase coil. Further, remaining three stator coils 22 are electrically connected to each other by a bus bar (not shown), so as to constitute a W-phase coil. One ends of respective phase coils constituted as such are connected to respective terminals (not shown) of respective phases, and the other ends thereof are connected to each other so as to form a neutral point. Hereby, the three phase coils are electrically connected to each other so as to constitute the entire stator coils 22.

The insulator 24 has a function to electrically insulate the stator core 20 from the stator coil 22. Further, the insulator 24 may have a function to fix the stator coil 22 to the stator core 20.

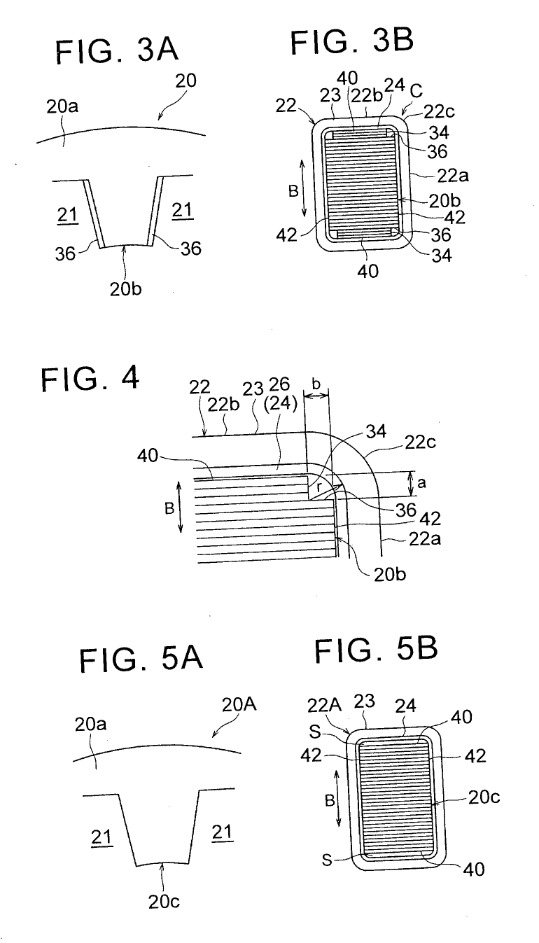

FIG. 2 is a perspective view of the insulator 24. In FIG. 2, the stator axial direction is indicated by an arrow B (which is also applied to FIGS. 3B, 4, 5B, 6B). As illustrated in FIG. 2, in a state where the insulator 24 is assembled to the tooth 20b of the stator core 20, the insulator 24 integrally includes a tubular portion 26 in which to accommodate the tooth 20b, and a flange portion 28 having an oblong frame shape that projects from an outer end of the tubular portion 26 in the stator radial direction. The flange portion 28 extends along an outward direction perpendicular to the stator radial direction from the end of the tubular portion 26.

The tubular portion 26 of the insulator 24 includes a space 30 having a rectangular-solid shape thereinside. The space 30 is formed to have a shape and a dimension that allow the tooth 20b of the stator core 20 to be accommodated therein. Those stator-axial-direction wall portions 26a of the tubular portion 26 which form the space 30 extend from the flange portion 28 along the stator radial direction. Further, stator-circumferential-direction wall portions 26b of the tubular portion 26 each extend from the flange portion 28 along each stator-circumferential-direction side face of the tooth 20b having a trapezoidal shape. Four corner portions 27 defined by the stator-axial-direction wall portions 26a and the stator-circumferential-direction wall portions 26b of the tubular portion 26 are formed in a shape curved in a generally arc shape with a predetermined curvature radius r so as to correspond to corner shapes of the tooth 20b to be described later.

The tubular portion 26 and the flange portion 28 constituting the insulator 24 can be molded integrally by injection molding by use of insulating resin such as polyphenylenesulfide (PPS). Further, an opening 32 via which the insulator 24 is inserted into the tooth 20b from the radially inner side is formed in the flange portion 28.

Note that a thickness of the tubular portion 26 and the flange portion 28 of the insulator 24 is designed in consideration of insulating properties between the stator core 20 and the stator coil 22, strength that prevents damage at the time of assembling and an operation of the rotary electric machine, and so on. However, it is preferable that the tubular portion 26 and the flange portion 28 be formed as thin as possible. Forming the tubular portion 26 and the flange portion 28 to be thin as such can contribute to a reduction in length of the coil lead wire 23 constituting the stator coil 22 and improvement in a space factor in a slot. However, the insulator 24 is not essential and may be omitted. In this case, in order to secure insulation of the stator coil 22 with respect to the stator core 20, other means may be performed, for example, such that the stator coil 22 is impregnated with insulating resin such as varnish and the insulating resin is then cured, or such that insulating paper is used instead.

FIG. 3A is a plan view of one tooth 20b when viewed in the stator axial direction, and FIG. 3B is a sectional view taken along a line A-A in FIG. 1. Further, FIG. 4 is a partial enlarged view of a part C in FIG. 3B. Further, FIG. 5 illustrates a comparative example in which a width of a tooth in the section along the line A-A in FIG. 1 is uniform along the axial direction: FIG. 5A is a plan view of one tooth 20c when viewed in the stator axial direction; and FIG. 5B is a sectional view of the tooth 20c of the comparative example in a direction perpendicular to a stator radial direction.

As illustrated in FIGS. 3A, 3B, a width, along the stator circumferential direction, of the tooth 20b of the stator core 20 in the present embodiment is configured such that both ends of the tooth 20b in the stator axial direction (an arrow-B direction) are each formed as a reduced-width part 34 having a width smaller than the other parts. More specifically, the reduced-width part 34 is formed such that a stator-circumferential-direction width of a tooth part of at least one magnetic plate laminated on an end in the stator axial direction is narrower than a stator-circumferential-direction width of tooth parts of magnetic plates laminated in a central part in the stator axial direction. The reduced-width part indicates a second portion or a third portion. Further, that part of the tooth 20b which has a wide stator-circumferential-direction width indicates a first portion. The present embodiment shows an example in which three magnetic plates have a tooth portion with a narrow width.

By providing the reduced-width part 34, a stepped portion 36 is formed in each of four corners defined by both axial end surfaces 40 and circumferential side faces 42 in the tooth 20b, as illustrated in FIG. 3B. The stepped portions include a first corner portion and a second corner portion. Further, the coil lead wire is formed such that a curved portion 22c continuing from a slot lead wire portion 22a placed inside the slot 21 of the stator core 20 to a coil end portion 22b, which is a stator-axial-direction end of the stator coil 22, corresponds to at least part of the reduced-width part 34. The curved portion 22c is placed in any of regions defined by a straight line passing through a centroid of the first portion along the stator circumferential direction and a straight line passing through the centroid of the first portion along the stator axial direction. Further, on a cross-section of the tooth, a straight line connecting the first corner portion to the second corner portion is placed between a center of the stator coil and a vertex of an arc of the curved portion.

The curved portion 22c of the stator coil 22 is described in detail with reference to FIG. 4. A direction of a stator-coil winding axis corresponds to the stator radial direction. That corner portion 27 of the tubular portion 26 of the insulator 24 which is formed in a curved manner is placed so as to cover an outer side of the stepped portion 36 formed by the reduced-width part 34 of the tooth 20b of the stator core 20. Here, an outer peripheral surface of the corner portion 27 of the tubular portion 26 is formed in an arc shape having a curvature radius r. It is preferable that the curvature radius r be set generally equivalent to the curvature radius r on an inner peripheral side of the curved portion 22c of the stator coil 22. This causes such an advantage that the stator coil 22 is stably placed on the tubular portion 26 of the insulator 24 without any gap, thereby making it possible to restrain occurrence of vibration, noise, and the like.

In terms of the stepped portion 36 formed by the reduced-width part 34, when an axial dimension is assumed a and a circumferential dimension is assumed b, it is preferable to set a≧b, and it is more preferable to set a=b. By setting a to be larger than b, the coil lead wire 23 continuing from the slot 21 to the coil end portion 22b via the curved portion 22c that is curved with a curvature radius r can be easily wound through a position near the axial end surface 40 of the tooth 20b. Further, in a case where the thickness of the tubular portion 26 of the insulator 24 is not considered, it is preferable that the axial dimension a of the stepped portion 36 be set to be equal to or larger than the curvature radius r of the curved portion 22c of the stator coil 22, and it is more preferable to set a=r. In a case where the thickness of the tubular portion 26 of the insulator 24 is assumed t, it is preferable to set a+t=r. Note that the axial dimension a of the stepped portion 36 may be set to be larger than the curvature radius r of the curved portion 22c, so that the curved portion 22c corresponds to a part of the reduced-width part 34.

Here, in a case where the curvature radius r of the curved portion 22c of the stator coil 22 is small, an inner peripheral side of the coil lead wire 23 becomes thick and a gap is formed between coil lead wires 23 adjacent to each other in the stator radial direction, which leads to a decrease in a space factor. Further, an insulating coating is stretched to be thin on an outer side of the coil lead wire 23, which may decrease insulating properties. On the other hand, in a case where the curvature radius r is large, the coil lead wire 23 extending from the slot 21 is largely projected axially outwardly, so that the coil end portion 22b becomes large, thereby resulting in that the rotary electric machine 10 is upsized. Accordingly, in consideration of these points, the curvature radius r of the stator coil 22 is set appropriately according to bending rigidity and the like of the coil lead wire 23.

The insulator 24 and the stator coil 22 are inserted radially from the tip of the tooth 20b so as to be assembled to the tooth 20b of the stator core 20 configured as described above. At this time, an adhesive material may be applied to an external surface of the flange portion 28 of the insulator 24 and an inner peripheral surface of the tubular portion 26, so that the insulator 24 is bonded and fixed to the stator core 20. Further, the stator coil 22 may be assembled to the stator core 20 in a state where the stator coil 22 is placed on the tubular portion 26 of the insulator 24 in advance, or the stator coil 22 may be attached after the insulator 24 is assembled.

FIG. 5 illustrates a comparative example in which a tooth width in the section along the line A-A in FIG. 1 is uniform along the stator axial direction: FIG. 5A is a plan view of one tooth when viewed in the stator axial direction; and FIG. 5B is a sectional view of the tooth 20c of the comparative example in a direction perpendicular to a stator radial direction. Referring to FIG. 5, a coil lead wire 23 constituting a stator coil 22 of concentrated winding is wound so as to be curved from a position where the coil lead wire 23 comes out from a slot 21 and to form a coil end portion along a stator-axial-direction end surface 40 of the tooth 20c. At this time, in a case where the coil lead wire 23 is a flat lead wire having relatively high rigidity, it is necessary for a curved portion to have a large curvature radius to some extent, so that a gap S is formed between the coil lead wire 23 and the stator-axial-direction end surface of the tooth 20c in the coil end portion. This results in that a length of the coil lead wire 23 constituting the stator coil 22 becomes longer by just that much. As a result, loss such as copper loss and cost are increased.

In contrast, according to the stator 12 of the present embodiment, since the stator coil 22 wound in a concentrated manner is configured such that the curved portion 22c continuing from the slot 21 of the stator core 20 to the coil end portion 22b, which is a stator-axial-direction end of the stator coil, corresponds to the reduced-width part 34, the coil lead wire 23 constituting the stator coil 22 can be curved from a position opposed to the reduced-width part 34 in the stator circumferential direction, so as to be wound through a position close to an axial end surface of the tooth 20b. This makes it possible to relatively shorten a length of the coil lead wire 23. Accordingly, it is possible to restrain loss such as copper loss by just that much, and to achieve cost reduction of the stator coil 22. In addition, it is possible to form the coil end portion 22b with a small size, which can contribute to downsizing of the stator 12 and the rotary electric machine 10 including the stator 12.

Further, in the present embodiment, since the stepped portions 36 are formed by the reduced-width parts 34, which are provided on both axial ends of the tooth 20b, it is possible to restrain the insulator 24 and the stator coil 22 from being damaged by corners of the tooth 20b at the time when the stator coil 22 is radially assembled from the tip of the tooth 20b.

Further, since the corner portion 27 of the tubular portion 26 of the insulator 24 is formed in a curved manner so as to have a generally arc shape corresponding to the stepped portion 36 of the tooth 20b, it is possible to restrain the insulating coating of the curved portion 22c of the stator coil 22 from being damaged at the time when the stator coil 22 is assembled to the insulator 24.

Further, in the present embodiment, the insulator 24 and the stator coil 22 are formed independently and separately from each other so as to be able to be assembled to the tooth 20b, so that they do not receive any stress after the assembling. As a result, the stator coil 22 can be attached to the stator core 20 while maintaining its desired shape, and damages to the insulator 24 are hardly caused.

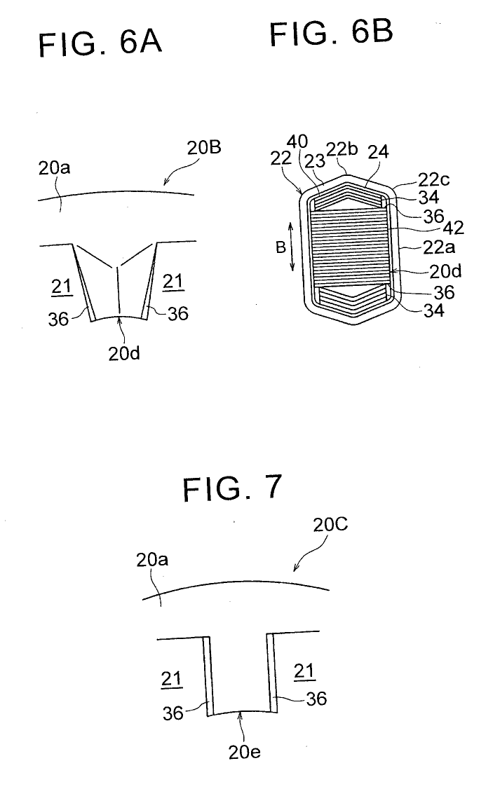

Next will be described a stator according to another embodiment, with reference to FIG. 6. In this stator, the same constituent as the stator 12 described above has the same reference sign as the stator 12 described above, and a redundant description is omitted.

As illustrated in FIG. 6, in a tooth 20d in a stator core 20B of this stator, tooth parts of magnetic plates laminated in both axial ends are formed so as to have a V-shape projecting axially outwardly, thereby forming reduced-width parts 34. In other words, on a cross-section of the tooth, a second portion and a third portion have a V-shape projecting outwardly in the stator axial direction. The present embodiment shows an example in which tooth parts of four magnetic plates laminated in an axial end are bent so as to have a V-shape projecting outwardly in the stator axial direction, so as to form the reduced-width part 34.

Further, a tubular portion 26 of an insulator 24 is configured such that both axial ends thereof have a mountain shape with an obtuse vertex angle, so as to correspond to the reduced-width parts 34 thus formed. A stator coil 22 is formed in a shape in which its coil end portion 22b is along the tubular portion 26 of the insulator 24. The other configuration except this is similar to the aforementioned stator 12.

According to the stator of the present embodiment, it is possible to yield the same effect as above. In addition, in the present embodiment, a curvature radius of that curved portion 22c of the stator coil 22 which continues from a slot lead wire portion 22a placed inside a slot 21 to a coil end portion 22b can be set larger than the aforementioned stator 12. Accordingly, the configuration described herein is suitable to restrain a decrease in insulating properties due to thickening of the curved portion 22c on an inner side and thinning of an insulating coating an outer side.

Note that the stator for the rotary electric machine according to the present invention is not limited to the above embodiment, and various modifications and alternations can be made within a range of what is described in Claims of the present application and its equivalent range.

For example, the stator 12 of the above embodiment described above deals with a case where the tooth 20b has a trapezoidal shape when viewed in the stator axial direction. However, the present invention is not limited to this, and the present invention may be applied to a stator configured such that a circumferential width of a tooth 20e is uniform over a stator radial direction as illustrated in FIG. 7.

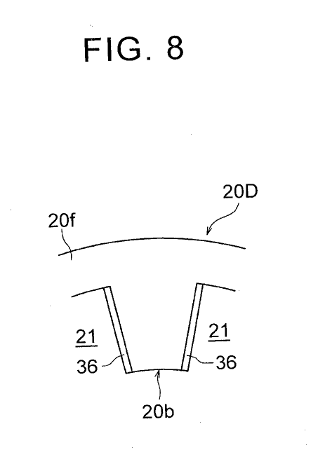

Further, the stator 12 of the embodiment described above is configured such that the yoke 20a of the stator core 20 is wide in radial width at respective root portions of the teeth 20b, but is narrowest in radial width at respective central positions of the slots 21 in the stator circumferential direction. However, the present invention is not limited to this, and an annular yoke 20f having a uniform radial width over the stator radial direction may extend in an arc shape between teeth 20b as illustrated in FIG. 8.

What is claimed is:

1. A stator for a rotary electric machine, the stator comprising:
a stator core including an annular yoke extending in a stator circumferential direction, and teeth projecting from the yoke in a stator radial direction,
the teeth being located at predetermined pitches in the stator circumferential direction,
the stator core being a plurality of magnetic plates laminated in a stator axial direction,
each of the magnetic plates being in an annular shape,
both ends of each of the teeth in the stator axial direction including reduced-width parts,
a width of each of the reduced-width parts being smaller than a width of a remaining part of each of the teeth; and
stator coils each being wound around corresponding one of the teeth in concentrated winding,
each of the stator coils including at least one curved portion at which each of the stator coils is curved,
the curved portion continuing from one of slots of the stator core to one of coil end portions that are end portions of the stator coils in the stator axial direction,
the curved portion corresponding in position to at least part of each of the reduced-width parts.

2. The stator for the rotary electric machine, according to claim 1, wherein
the magnetic plates laminated in the reduced-width parts have a V-shape projecting outwardly in the stator axial direction.

3. The stator for the rotary electric machine, according to claim 1, wherein
each of the teeth has a trapezoidal shape when viewed in the stator axial direction.

4. A stator for a rotary electric machine, the stator comprising:
a stator core including an annular yoke and teeth,
the teeth projecting from the yoke toward a radially inner side of the stator,
the teeth being provided in the yoke at predetermined pitches in a stator circumferential direction,
the yoke and the teeth being a plurality of magnetic plates laminated in a stator axial direction,
the teeth each including a first portion, a second portion, and a third portion,
the first portion, the second portion, and the third portion being placed in the stator axial direction in order of the second portion, the first portion, and the third portion,
a width of the first portion in the stator circumferential direction being larger than a width of the second portion in the stator circumferential direction,
the width of the first portion in the stator circumferential direction being larger than a width of the third portion in the stator circumferential direction,
stepped portions being defined respectively by the first portion and the second portion and by the first portion and the third portion,
the stepped portions each including a first corner portion and a second corner portion; and
a stator coil being a concentrated winding coil,
the stator coil being wound around corresponding one of the teeth,
the stator coil including a plurality of curved portions,
a straight line connecting the first corner portion to the second corner portion being placed between a center of the stator coil and a vertex of an arc of each of the curved portions on a cross-section of each of the teeth.

5. The stator for the rotary electric machine, according to claim 4, wherein
the second portion and the third portion each have a V-shape projecting outwardly in the stator axial direction on the cross-section of each of the teeth.

6. The stator for the rotary electric machine, according to claim 4, wherein
each of the teeth has a trapezoidal shape when viewed in the stator axial direction.
